(19) United States
(12) Patent Application Publication
(10) Pub. No.: US 2024/0321490 A1
(43) Pub. Date: Sep. 26, 2024

(54) R-T-B BASED PERMANENT MAGNET

(71) Applicant: TDK Corporation, Tokyo (JP)

(72) Inventor: Takuma HAYAKAWA, Tokyo (JP)

(73) Assignee: TDK Corporation, Tokyo (JP)

(21) Appl. No.: 18/610,601

(22) Filed: Mar. 20, 2024

(30) Foreign Application Priority Data
Mar. 23, 2023 (JP) 2023-047171
Feb. 5, 2024 (JP) 2024-015723

(51) Int. Cl. H01F 1/057; B22F 3/16; B22F 3/24; B22F 9/02; B22F 9/04; C22C 38/00; C22C 38/06; C22C 38/10; C22C 38/14; C22C 38/16; H01F 41/02

(52) U.S. Cl. CPC H01F 1/0577; B22F 3/162; B22F 3/24; B22F 9/023; B22F 9/04; C22C 38/002; C22C 38/005; C22C 38/06; C22C 38/10; C22C 38/14; C22C 38/16; B22F 2003/242; B22F 2003/247; B22F 2003/248; B22F 2009/044; B22F 2201/11; B22F 2201/20; B22F 2202/05; B22F 2301/355; B22F 2304/10; B22F 2998/10; B22F 2999/00; C22C 2202/02; H01F 41/0266; H01F 41/0293

(57) ABSTRACT

An R-T-B based permanent magnet has a heavy rare earth element content of 0.30 mass % or less excluding 0 mass %. The R-T-B based permanent magnet is either an R-T-B based permanent magnet including at least a rare earth element, Fe, Co, Al, Zr, Ga, B, and C within predetermined ranges; or an R-T-B based permanent magnet including main phase grains including crystal grains having an R₂T₁₄B type crystal structure and a grain boundary between two or more of the main phase grains adjacent to each other, having an R—Fe—Co—Ga—Al concentrated portion in the grain boundary.

### CROSS-REFERENCE TO RELATED APPLICATIONS

This application claims priority to Japanese patent application No. 2023-047171, filed on Mar. 23, 2023, and No. 2024-015723, filed on Feb. 5, 2024, each is incorporated herein by reference in its entirety.

### TECHNICAL FIELD

The present disclosure relates to an R-T-B based permanent magnet.

### BACKGROUND

Patent Document 1 discloses an R-T-B based permanent magnet having a low Co content and excellent magnetic properties and corrosion resistance.
Patent Document 1: JP Patent Application Laid Open No. 2020-161812

### SUMMARY

It is an object of an aspect of the present disclosure to provide an R-T-B based permanent magnet with excellent corrosion resistance and magnetic properties (in particular, coercive force at room temperature and coercive force at high temperatures) despite having a low heavy rare earth element content.

To achieve the above object, an R-T-B based permanent magnet according to an aspect of the present disclosure includes at least a rare earth element, Fe, Co, Al, Zr, Ga, B, and C, the rare earth element including a heavy rare earth element,
wherein the R-T-B based permanent magnet has
a rare earth element content of 28.50 mass % or more and 31.50 mass % or less,
a heavy rare earth element content of 0.30 mass % or less excluding 0 mass %,
a Co content of 0.20 mass % or more and 0.80 mass % or less,
an Al content of 0.40 mass % or more and 0.85 mass % or less,
a Zr content of 0.21 mass % or more and 0.85 mass % or less,
a Ga content of 0.04 mass % or more and 0.40 mass % or less,
a B content of 0.90 mass % or more and 1.02 mass % or less,
a C content of 0.05 mass % or more and 0.11 mass % or less, and
an O content of 0 mass % or more and 0.12 mass % or less.

The Ga content divided by the Al content based on mass may be 0.04 or more and 0.59 or less.

The C content divided by a total of the Zr content and the B content based on mass may be 0.026 or more and 0.095 or less.

The R-T-B based permanent magnet may have a distribution of concentrations of the heavy rare earth element decreasing from a surface of the R-T-B based permanent magnet inwards.

To achieve the above object, an R-T-B based permanent magnet according to another aspect of the present disclosure includes
main phase grains including crystal grains having an R₂T₁₄B type crystal structure; and
a grain boundary between two or more of the main phase grains adjacent to each other, wherein
the grain boundary includes an R—Fe—Co—Ga—Al concentrated portion;
the R—Fe—Co—Ga—Al concentrated portion includes a portion containing Fe, having a rare earth element concentration higher than an average rare earth element concentration of the main phase grains, having a Co concentration higher than an average Co concentration of the main phase grains, having a Ga concentration higher than an average Ga concentration of the main phase grains, and having an Al concentration higher than an average Al concentration of the main phase grains; and
the R-T-B based permanent magnet has a heavy rare earth element content of 0.30 mass % or less excluding 0 mass %.

The R-T-B based permanent magnet may include the R—Fe—Co—Ga—Al concentrated portion at a near center of the R-T-B based permanent magnet.

The R-T-B based permanent magnet may include at least a rare earth element, Fe, Co, Al, Zr, Ga, B, and C and may have
a rare earth element content of 28.50 mass % or more and 31.50 mass % or less,
a Co content of 0.20 mass % or more and 0.80 mass % or less,
an Al content of 0.40 mass % or more and 0.85 mass % or less,
a Zr content of 0.21 mass % or more and 0.85 mass % or less,
a Ga content of 0.04 mass % or more and 0.40 mass % or less,
a B content of 0.90 mass % or more and 1.02 mass % or less,
a C content of 0.05 mass % or more and 0.11 mass % or less, and
an O content of 0 mass % or more and 0.12 mass % or less.

### BRIEF DESCRIPTION OF THE DRAWING(S)

FIG. 1 is a schematic view of an R-T-B based permanent magnet according to an embodiment.

FIG. 2 is a set of elemental mapping images of a near center of a Sample No. 4 magnet.

FIG. 3 is a set of elemental mapping images of the vicinity of a surface of the Sample No. 4 magnet.

FIG. 4 is a set of elemental mapping images of a near center of a Sample No. 15 magnet.

### DETAILED DESCRIPTION

### First Embodiment

Hereinafter, the present disclosure is described with reference to an embodiment illustrated in the drawings.

### <R-T-B Based Permanent Magnet>

An R-T-B based permanent magnet according to the present embodiment includes main phase grains including crystal grains having an R₂T₁₄B type crystal structure. The R-T-B based permanent magnet further includes grain boundaries each formed between two or more of the main phase grains adjacent to each other. In particular, a grain boundary between two adjacent main phase grains is referred to as a two-grain boundary, and a grain boundary between three or more main phase grains is referred to as a triple junction.

In the R-T-B based permanent magnet and the R₂T₁₄B type crystal structure, “R” represents at least one rare earth element, “T” represents at least one transition metal element, and “B” represents boron.

At least one rare earth element contained as “R” in the R-T-B based permanent magnet and the R₂T₁₄B type crystal structure may include Sc, Y, and lanthanoid or may include Y and lanthanoid. At least one transition metal element contained as “T” does not include rare earth elements. The at least one transition metal element contained as “T” may include an iron group element. Boron contained as “B” may be partly substituted by carbon.

The R-T-B based permanent magnet according to the present embodiment may have any shape.

By containing specific elements within specific content ranges, the R-T-B based permanent magnet according to the present embodiment can have an improved residual flux density (Br), coercive force (HcJ), squareness (Hk/HcJ), and corrosion resistance. Further, the R-T-B based permanent magnet can have both improved HcJ at room temperature and improved HcJ at high temperatures. Br and Hk/HcJ are those at room temperature.

The R-T-B based permanent magnet according to the present embodiment may have a distribution of concentrations of a heavy rare earth element or elements decreasing from an outer side of the R-T-B based permanent magnet 1 to its inner side. Any heavy rare earth element or elements may be contained. For example, Dy or Tb may be contained, or Tb may be contained.

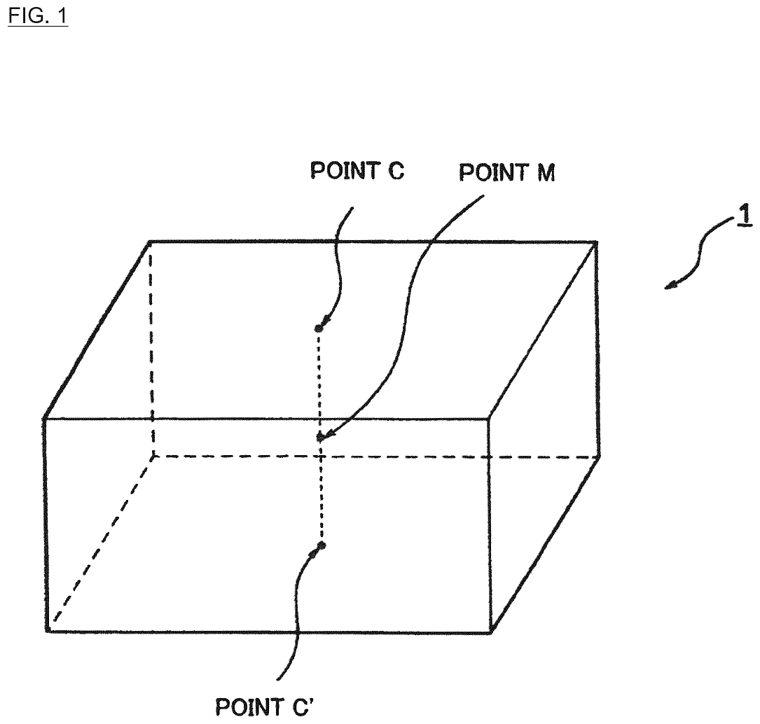

Specifically, as shown in FIG. 1, the R-T-B based permanent magnet 1 according to the present embodiment having a rectangular parallelepiped shape has surface portions and a center portion, and the heavy rare earth element content of the surface portions may be higher than that of the center portion by 2% or more, 5% or more, or 10% or more based on mass. The surface portions mean surfaces of the R-T-B based permanent magnet 1. For example, POINT C and POINT C′ shown in FIG. 1 (centroids of surfaces facing each other in FIG. 1) are the surface portions. The center portion means a center of the R-T-B based permanent magnet 1. For example, the center portion is at half the thickness of the R-T-B based permanent magnet 1. For example, POINT M shown in FIG. 1 (a midpoint between POINT C and POINT C′) is the center portion. POINT C and POINT C′ of FIG. 1 may be a centroid of a surface having the largest area among surfaces of the R-T-B based permanent magnet 1 and a centroid of a surface facing the former surface, respectively.

In general, rare earth elements are classified into light rare earth elements and heavy rare earth elements. Light rare earth elements of the R-T-B based permanent magnet according to the present embodiment include Sc, Y, La, Ce, Pr, Nd, Sm, and Eu. Heavy rare earth elements of the R-T-B based permanent magnet according to the present embodiment include Gd, Tb, Dy, Ho, Er, Tm, Yb, and Lu.

Any method of providing the R-T-B based permanent magnet according to the present embodiment with the above-mentioned heavy rare earth element concentration distribution may be used. For example, grain boundary diffusion (described later) of a heavy rare earth element or elements can be used to provide the R-T-B based permanent magnet with the heavy rare earth element concentration distribution.

The main phase grains of the R-T-B based permanent magnet according to the present embodiment may be core-shell grains each including a core and a shell covering the core. Further, at least the shell may contain a heavy rare earth element or elements; Dy or Tb; or Tb.

By containing the heavy rare earth element or elements in the shell, the R-T-B based permanent magnet can have efficiently improved magnetic properties.

In the present embodiment, the shell is defined as a portion where the ratio of heavy rare earth elements to light rare earth elements (heavy rare earth elements/light rare earth elements (molar ratio)) is at least two times the ratio at a center portion of each main phase grain. The ratio at the center portion of the main phase grain may be, for example, the ratio at a portion located at a depth that is at least 30% of the particle size from a surface of the main phase grain.

The shell may have any thickness. The thickness may be 500 nm or less on average. The main phase grains may have any grain size. The grain size may be 1.0 μm or more and 6.5 μm or less on average. To calculate these averages, a section of the R-T-B based permanent magnet may be observed with a SEM, and a field of view having a size large enough to include at least fifty core-shell grains may be determined. Thicknesses of the shells of all core-shell grains in the field of view may be measured and averaged. Also, grain sizes of all main phase grains in the field of view may be measured and averaged. The field of view may have a size of, for example, 100 μm×100 μm.

Any method of making the main phase grains become the above-mentioned core-shell grains may be used. For example, a method involving grain boundary diffusion described later may be used. As the heavy rare earth element or elements diffuse to the grain boundaries and substitute for a rare earth element or elements on surfaces of the main phase grains, the shells with a high percentage of heavy rare earth elements are formed, resulting in the core-shell grains.

The R-T-B based permanent magnet according to the present embodiment may contain at least one selected from the group consisting of Nd and Pr as a light rare earth element and at least one selected from the group consisting of Dy and Tb as a heavy rare earth element. The R-T-B based permanent magnet according to the present embodiment may contain at least Nd and Tb.

Out of 100 mass % of the entire mass of the R-T-B based permanent magnet according to the present embodiment, the total rare earth element content other than Nd, Pr, Dy, and Tb of the R-T-B based permanent magnet may be 0.3 mass % or less, or the total rare earth element content other than Nd, Pr, and Tb thereof may be 0.3 mass % or less.

Out of 100 mass % of the entire mass of the R-T-B based permanent magnet according to the present embodiment, the total rare earth element content (TRE) of the R-T-B based permanent magnet is 28.50 mass % or more and 31.50 mass % or less. TRE may be 29.50 mass % or more and 31.10 mass % or less. When TRE is low, HcJ at room temperature (23±1° C.), HcJ at high temperatures (100° C. or higher and 200° C. or lower), and Hk/HcJ tend to decrease. When TRE is high, Br and corrosion resistance tend to decrease.

The R-T-B based permanent magnet according to the present embodiment may have any total light rare earth element content. Out of 100 mass % of the entire mass of the R-T-B based permanent magnet, the total light rare earth element content may be 28.25 mass % or more and 31.25 mass % or less or may be 29.25 mass % or more and 30.85 mass % or less.

When the R-T-B based permanent magnet contains at least one selected from the group consisting of Nd and Pr, the Pr content may be 0.0 mass % or more and 10.0 mass % or less or may be 0.0 mass % or more and 7.6 mass % or less.

The Pr content divided by a total of the Nd content and the Pr content based on mass may be 0 or more and 0.35 or less.

It may be that the R-T-B based permanent magnet according to the present embodiment intentionally does not contain Pr. When Pr is intentionally not contained, HcJ at high temperatures tends to increase. When Pr is intentionally not contained, the R-T-B based permanent magnet may contain less than 0.2 mass % Pr or 0.1 mass % or less Pr as impurities.

Out of 100 mass % of the entire mass of the R-T-B based permanent magnet according to the present embodiment, the total heavy rare earth element content (HRE) of the R-T-B based permanent magnet is 0.30 mass % or less (excluding 0 mass %). Too high a heavy rare earth element content increases raw material costs and further tends to decrease Br. The total heavy rare earth element content may be 0.10 mass % or more and 0.30 mass % or less or may be 0.15 mass % or more and 0.25 mass % or less.

Out of 100 mass % of the entire mass of the R-T-B based permanent magnet, the Co content of the R-T-B based permanent magnet is 0.20 mass % or more and 0.80 mass % or less. The Co content may be 0.40 mass % or more and 0.70 mass % or less. When the Co content is high, raw material costs tend to increase. When the Co content is low, corrosion resistance tends to decrease.

The Fe content is substantially a balance of the R-T-B based permanent magnet, meaning that the balance of the R-T-B based permanent magnet excluding the above-mentioned rare earth elements and Co as well as B, Al, Zr, Ga, Cu, C, and O described later is substantially only Fe. For example, out of 100 mass % of the entire mass of the R-T-B based permanent magnet, the total content of elements other than rare earth elements, Fe, Co, B, Al, Zr, Ga, Cu, C, and O may be 1.0 mass % or less.

Out of 100 mass % of the entire mass of the R-T-B based permanent magnet according to the present embodiment, the B content of the R-T-B based permanent magnet is 0.90 mass % or more and 1.02 mass % or less. The B content may be 0.90 mass % or more and 0.98 mass % or less. When the B content is low, Hk/HcJ and HcJ at high temperatures tend to decrease. When the B content is high, HcJ and HcJ at high temperatures tend to decrease.

The R-T-B based permanent magnet according to the present embodiment further contains Al. Out of 100 mass % of the entire mass of the R-T-B based permanent magnet, the Al content is 0.40 mass % or more and 0.85 mass % or less. The Al content may be 0.48 mass % or more and 0.80 mass % or less. When the Al content is low, HcJ at room temperature and HcJ at high temperatures tend to decrease. When the Al content is high, Br and HcJ at high temperatures tend to decrease.

The R-T-B based permanent magnet according to the present embodiment further contains Zr. Out of 100 mass % of the entire mass of the R-T-B based permanent magnet, the Zr content is 0.21 mass % or more and 0.85 mass % or less. The Zr content may be 0.32 mass % or more and 0.68 mass % or less. When the Zr content is low, HcJ at room temperature, HcJ at high temperatures, and Hk/HcJ tend to decrease. When the Zr content is high, Br tends to decrease.

The R-T-B based permanent magnet according to the present embodiment further contains Ga. Out of 100 mass % of the entire mass of the R-T-B based permanent magnet, the Ga content is 0.04 mass % or more and 0.40 mass % or less. The Ga content may be 0.08 mass % or more and 0.36 mass % or less. When the Ga content is low, HcJ at room temperature and HcJ at high temperatures tend to decrease. When the Ga content is high, Br tends to decrease.

The R-T-B based permanent magnet according to the present embodiment may further contain Cu. Out of 100 mass % of the entire mass of the R-T-B based permanent magnet, the Cu content may be 0.03 mass % or more and 0.50 mass % or less, 0.04 mass % or more and 0.45 mass % or less, or 0.05 mass % or more and 0.40 mass % or less.

The R-T-B based permanent magnet according to the present embodiment further contains C. Out of 100 mass % of the entire mass of the R-T-B based permanent magnet, the C content is 0.05 mass % or more and 0.11 mass % or less. The C content may be 0.07 mass % or more and 0.09 mass % or less. When the C content is low, Br tends to decrease. When the C content is high, HcJ at room temperature, HcJ at high temperatures, and Hk/HcJ tend to decrease.

The R-T-B based permanent magnet according to the present embodiment may further contain O. Out of 100 mass % of the entire mass of the R-T-B based permanent magnet, the O content is 0 mass % or more and 0.12 mass % or less. The O content may be 0.06 mass % or more and 0.11 mass % or less. When the O content is low, manufacturing costs of the R-T-B based permanent magnet tend to increase, because it is required to lower the oxygen concentration of an atmosphere used in manufacture of the R-T-B based permanent magnet with a low O content. When the O content is high, Br, HcJ at room temperature, and HcJ at high temperatures tend to decrease.

“Ga/Al”, which is the Ga content of the R-T-B based permanent magnet according to the present embodiment divided by the Al content thereof based on mass, may be 0.04 or more and 0.59 or less or may be 0.10 or more and 0.53 or less. By Ga/Al being the above-mentioned range, the R-T-B based permanent magnet tends to have good Br, good HcJ at room temperature, good HcJ at high temperatures, good Hk/HcJ, and good corrosion resistance.

“C/(Zr+B)”, which is the C content of the R-T-B based permanent magnet according to the present embodiment divided by a total of the Zr content and the B content thereof based on mass, may be 0.026 or more and 0.095 or less or may be 0.031 or more and 0.090 or less. By C/(Zr+B) being the above-mentioned range, the R-T-B based permanent magnet tends to have good Br, good HcJ at room temperature, good HcJ at high temperatures, good Hk/HcJ, and good corrosion resistance.

The R-T-B based permanent magnet according to the present embodiment may contain elements besides the above rare earth elements, Fe, Co, Al, Zr, Ga, Cu, B, C, and O, as other elements. The content of the other elements is not limited and may be as high as not to significantly influence the magnetic properties or the corrosion resistance of the R-T-B based permanent magnet. For example, out of 100 mass % of the entire mass of the R-T-B based permanent magnet, the content of each of the other elements may be 0.10 mass % or less, and the total content of the other elements may be 1.0 mass % or less.

As for a method of measuring various components included in the R-T-B based permanent magnet according to the present embodiment, conventionally and generally known methods can be used. The content of various elements is measured by, for example, an X-ray fluorescence analysis or inductively coupled plasma emission spectroscopic analysis (ICP analysis). The O content is measured by, for example, an inert gas fusion—nondispersive infrared absorption method. The C content is measured by, for example, a combustion in oxygen stream—infrared absorption method.

The R-T-B based permanent magnet according to the present embodiment may have any shape, such as a rectangular parallelepiped shape or a C shape.

Hereinafter, an example method of manufacturing the R-T-B based permanent magnet according to the present embodiment is described in detail. However, methods of manufacturing the R-T-B based permanent magnet are not limited to this example method, and other known methods may be used.

[Raw material powder preparation step]A raw material powder can be produced using a known method. The following description is provided on the premise that a one-alloy method, in which a single alloy is used, is employed in the present embodiment; however, a so-called two-alloy method, in which two or more alloys having different compositions are mixed to produce a raw material powder, may be employed.

First, a raw material alloy of the R-T-B based permanent magnet is prepared (an alloy preparation step). In the alloy preparation step, raw material metals corresponding to the composition of the R-T-B based permanent magnet according to the present embodiment are melted by a known method and are then casted to give the raw material alloy having a desired composition.

Examples of the raw material metals can include simple substances of rare earth elements, simple substances of metal elements (e.g., Fe, Co, and Al), alloys containing more than one metal (e.g., Fe—Co alloys), and compounds containing more than one element (e.g., ferroboron), as appropriate. Any casting method of casting the raw material alloy from the raw material metals may be used. For the R-T-B based permanent magnet to have high magnetic properties, a strip casting method may be used. The resultant raw material alloy may be subject to a homogenization treatment by a known method as necessary.

After the raw material alloy is produced, it is pulverized (a pulverization step). In terms of attaining high magnetic properties, an atmosphere used for steps from the pulverization step to a sintering step can be an atmosphere with a low oxygen concentration. For example, the oxygen concentration of the atmosphere of the steps may be 200 ppm or less. Controlling the oxygen concentration of the atmosphere of the steps can control the O content of the R-T-B based permanent magnet.

Described below is a two-step process of the pulverization step, which includes a coarse pulverization step of pulverizing the raw material alloy to a particle size of about several hundred μm to about several mm and a fine pulverization step of finely pulverizing a coarsely pulverized powder to a particle size of about several μm. However, a one-step process consisting solely of the fine pulverization step may be carried out.

In the coarse pulverization step, the raw material alloy is coarsely pulverized until it has a particle size of about several hundred μm to about several mm. This provides the coarsely pulverized powder. Any coarse pulverization method may be used. Known methods, such as a hydrogen storage pulverization method or a method involving a coarse pulverizer, can be used.

Then, the resultant coarsely pulverized powder is finely pulverized until it has an average particle size of about several μm (fine pulverization step). This provides a finely pulverized powder (raw material powder). The average particle size of the finely pulverized powder may be 1 μm or more and 10 μm or less, 2 μm or more and 6 μm or less, or 2 μm or more and 4 μm or less.

Any fine pulverization method may be used. For example, fine pulverization is carried out with various fine pulverizers.

Adding various pulverization aids (e.g., lauramide or oleic amide) to the coarsely pulverized powder for fine pulverization can provide the finely pulverized powder such that crystal grains are readily oriented in a specific direction when pressed with pressure in a magnetic field. Also, changing the amount of the pulverization aids added can control the C content of the R-T-B based permanent magnet.

### [Pressing Step]

In a pressing step, the above-mentioned finely pulverized powder is pressed into an intended shape. Any pressing method may be used. According to the present embodiment, a mold is filled with the finely pulverized powder, and pressure is applied thereto in a magnetic field. Because a resultant green compact has crystal grains oriented in the specific direction, the R-T-B based permanent magnet can have higher Br.

The pressure applied during pressing can be 20 MPa or more and 300 MPa or less. The applied magnetic field can be 950 kA/m or more or can be 950 kA/m or more and 1600 kA/m or less. The magnetic field applied is not limited to a static magnetic field and can be a pulsed magnetic field. Also, a static magnetic field and a pulsed magnetic field can be used together.

As for a pressing method, other than dry pressing, in which the finely pulverized powder is directly pressed as described above, wet pressing can be used, in which a slurry including the finely pulverized powder dispersed in a solvent (e.g., oil) is pressed.

The green compact resulting from pressing the finely pulverized powder may have any shape. The green compact at this time can have a density of 4.0 Mg/m³ to 4.3 Mg/m³.

### [Sintering Step]

The sintering step is a step in which the green compact is sintered in a vacuum or an inert gas atmosphere to give a sintered body. Sintering conditions need to be adjusted according to conditions, such as a composition, a pulverization method, and a difference in particle size and particle size distribution. For example, the green compact is sintered through a heat treatment in a vacuum or an inert gas atmosphere at 1000° C. or higher and 1200° C. or lower for 1 hour or more and 20 hours or less. Sintering under the above-mentioned sintering conditions provides the sintered body with high density. In the present embodiment, the sintered body has a density of at least 7.45 Mg/m³. The density of the sintered body may be 7.50 Mg/m³ or more.

### [Aging Treatment Step]

An aging treatment step is a step in which the sintered body is heat treated (aging treatment) at a temperature lower than the sintering temperature. Whether the aging treatment is carried out or not is not limited, and the number of the aging treatment is also not limited. Description of the embodiment in which the aging treatment is carried out twice is provided below.

An aging step for the first time is referred to as a first aging step, and an aging step for the second time is referred to as a second aging step. The aging temperature of the first aging step is referred to as T1, and the aging temperature of the second aging step is referred to as T2.

T1 and the aging time of the first aging step are not limited. T1 can be 700° C. or higher and 950° C. or lower. The aging time can be 1 hour or more and 10 hours or less.

T2 and the aging time of the second aging step are not limited. T2 can be 450° C. or higher and 700° C. or lower. The aging time can be 1 hour or more and 10 hours or less.

### [Machining Step (Before Grain Boundary Diffusion)]

As necessary, a step of machining the sintered body according to the present embodiment into a desired shape may be employed. Examples of machining methods include shape machining (e.g., cutting or grinding) and chamfering (e.g., barrel polishing).

### [Grain Boundary Diffusion Step]

A grain boundary diffusion step can be performed by adhering a diffusing material to at least one surface of the sintered body and heating the sintered body having the diffusing material adhered. This provides the R-T-B based permanent magnet. In the present embodiment, the diffusing material may be of any type. The diffusing material may contain a hydride of a heavy rare earth element or elements (e.g., Tb) or may contain a heavy rare earth element or elements and Cu.

In the grain boundary diffusion step, grain boundary phases having a high rare earth element concentration present at grain boundaries of the magnet base material (sintered body) become liquid phases along with an increase in temperature, and melting of the diffusing material into the liquid phases diffuses components of the diffusing material from the at least one surface of the magnet base material to the interior of the magnet base material.

The magnet base material according to the present embodiment has characteristics, such as an Al content within a predetermined range. The diffusing material according to the present embodiment has the above characteristics.

Thus, in the present embodiment, the liquid phases generated during heating contain Al within a predetermined range. The rate of reaction between the components of the diffusing material and the liquid phases in the magnet base material containing Al is lower than that in a magnet base material that does not contain Al. Also, because volume diffusion of the heavy rare earth element or elements into main phase grains is prevented or reduced, the heavy rare earth element or elements are readily diffused to a center portion of the magnet base material. Thus, good properties are attained with a relatively small amount of diffusion of the heavy rare earth element or elements.

In the pre-grain boundary diffusion magnet base material, the main phase grains and the grain boundary phases have about the same Al concentration. Thus, the microstructure of the magnet base material has high interface integrity in the vicinity of the main phase grains at the time of grain boundary diffusion. Thus, it is assumed that, regardless of whether the aging treatment is carried out or not, sufficiently high properties or, in particular, sufficiently high coercive force, is attained. Not carrying out the aging treatment can reduce manufacturing costs.

The diffusing material may be a slurry including a solvent in addition to, for example, the above-mentioned hydride of the heavy rare earth element or elements. The solvent included in the slurry may be a solvent other than water. For example, the solvent may be an organic solvent, such as alcohol, an aldehyde, or a ketone. The diffusing material may further include a binder. The binder may be of any type. For example, resins such as acrylic resins may be included as the binder. Including the binder makes the diffusing material readily adhere to the at least one surface of the sintered body.

The diffusing material may be a paste including the solvent and the binder in addition to, for example, the above-mentioned hydride of the heavy rare earth element or elements. The paste has fluidity and high viscosity. The viscosity of the paste is higher than the viscosity of the slurry.

Before a diffusion treatment described later, the sintered body having the slurry or the paste adhered may be dried to remove the solvent and the binder.

The holding temperature during drying may be 200° C. or higher and 800° C. or lower, and the holding time during drying may be 10 minutes or more and 10 hours or less. The atmosphere during drying is an inert gas atmosphere. Drying the sintered body having the slurry or the paste adhered can prevent or reduce generation of a carbide of the heavy rare earth element or elements on the at least one surface of the magnet base material and can further reduce usage of the heavy rare earth element or elements.

The diffusion treatment of the grain boundary diffusion step according to the present embodiment may be performed consecutively from the above-mentioned drying. Also, the sintered body may once be cooled to room temperature after the above-mentioned drying and may then be heated again. The holding temperature during the diffusion treatment may be 700° C. or higher and 1000° C. or lower. In the grain boundary diffusion step, the temperature of the magnet base material may be gradually increased from a temperature lower than a diffusion treatment temperature to the diffusion treatment temperature.

The time (diffusion treatment time) during which the temperature of the base material is maintained at the diffusion treatment temperature may be, for example, 1 hour or more and 50 hours or less. The atmosphere around the base material in the diffusion treatment may be a non-oxidizing atmosphere. The non-oxidizing atmosphere may be, for example, a noble gas (e.g., argon) atmosphere. The pressure of the atmosphere around the magnet base material in the diffusion treatment may be 1 kPa or less. Such a reduced-pressure atmosphere facilitates dehydrogenation of the hydride, melting of the diffusing material into the liquid phases readily proceeds.

[Machining Step (after Grain Boundary Diffusion)]

After the grain boundary diffusion step, polishing may be carried out to remove the diffusing material remaining on the at least one surface of the R-T-B based permanent magnet. Also, the R-T-B based permanent magnet may be subject to other types of machining. For example, shape machining (e.g., cutting or grinding) or surface machining (e.g., chamfering, such as barrel polishing) may be carried out.

In the present embodiment, the machining steps are carried out before and after grain boundary diffusion; however, these steps do not necessarily have to be carried out.

In particular, the R-T-B based permanent magnet after grain boundary diffusion tends to have a distribution of concentrations of the heavy rare earth element or elements decreasing from an outer side of the R-T-B based permanent magnet to its inner side. Also, the main phase grains included in the R-T-B based permanent magnet after grain boundary diffusion tend to have the above-mentioned core-shell structure.

The R-T-B based permanent magnet according to the present embodiment resulting as such has desired properties. Specifically, the R-T-B based permanent magnet has high Br, high HcJ at room temperature, high HcJ at high temperatures, high Hk/HcJ, and excellent corrosion resistance.

Magnetizing the R-T-B based permanent magnet according to the present embodiment resulting from the above-mentioned method provides a magnetic R-T-B based permanent magnet.

The R-T-B based permanent magnet according to the present embodiment is suitably used for a motor, an electric generator, etc.

### Second Embodiment

Hereinafter, a second embodiment is described. The second embodiment is similar to the first embodiment unless otherwise specified.

### <R-T-B Based Permanent Magnet>

An R-T-B based permanent magnet according to the present embodiment includes main phase grains including crystal grains having an R₂T₁₄B type crystal structure. The R-T-B based permanent magnet further includes grain boundaries each provided between two or more of the main phase grains adjacent to each other. In particular, a grain boundary between two adjacent main phase grains is referred to as a two-grain boundary, and a grain boundary between three or more main phase grains is referred to as a triple junction.

The R-T-B based permanent magnet according to the present embodiment may include an R—Fe—Co—Ga—Al concentrated portion in the grain boundaries. The R—Fe—Co—Ga—Al concentrated portion is a portion containing Fe, having a rare earth element concentration higher than an average rare earth element concentration of the main phase grains, having a Co concentration higher than an average Co concentration of the main phase grains, having a Ga concentration higher than an average Ga concentration of the main phase grains, and having an Al concentration higher than an average Al concentration of the main phase grains.

The R—Fe—Co—Ga—Al concentrated portion may be provided at a near center of the magnet. When the magnet has a shape such as a rectangular parallelepiped shape, a region of the magnet having a centroid at the same location as the magnet, a shape substantially similar to that of the magnet, and a volume of 50% of the magnet may be defined as the near center of the magnet. When a section of the magnet is observed, a region of the section of the magnet having a centroid at the same location as the magnet, a shape substantially similar to that of the magnet, and an area of 50% of the magnet may be defined as the near center of the magnet. When the magnet has a shape such as a C shape, a region of the magnet that is located inwards from all surfaces of the magnet by 10% or more of the thickness of the magnet may be defined as the near center of the magnet. When the magnet has a C shape, a longest distance of a perpendicular line drawn substantially perpendicularly from an inner arc to an outer arc of the magnet may be defined as the thickness of the magnet. Portions of the magnet that are not at the near center may be defined as the vicinity of the surfaces of the magnet. Providing the grain boundaries with the R—Fe—Co—Ga—Al concentrated portion allows high corrosion resistance and high HcJ.

It is assumed that the R—Fe—Co—Ga—Al concentrated portion in the grain boundaries of the magnet reduces the proportion of an R—O phase having relatively low corrosion resistance, thereby improving the corrosion resistance of the magnet. The R—O phase is a phase having an “R” concentration higher than an average “R” concentration of the main phases and an O concentration higher than an average O concentration of the main phases. The R—O phase may further contain elements other than “R” and O, such as C or N.

When the grain boundaries of the magnet include the R—Fe—Co—Ga—Al concentrated portion, the magnet can have high HcJ through grain boundary diffusion described later. It is assumed that, because the R—Fe—Co—Ga—Al concentrated portion tends to contain Tb less than the R—O phase when Tb is diffused by a grain boundary diffusion process, dispersing the R—Fe—Co—Ga—Al concentrated portion in the grain boundaries makes Tb efficiently be diffused to the interior of the magnet, improving HcJ of the magnet.

Unlike the first embodiment, the composition of the R-T-B based permanent magnet of the present embodiment is not limited except for the heavy rare earth element content. From the point that the R—Fe—Co—Ga—Al concentrated portion is provided in the grain boundaries of the R-T-B based permanent magnet, the R-T-B based permanent magnet contains at least “R”, Fe, Co, Ga, and Al. The R-T-B based permanent magnet further contains a heavy rare earth element or elements. The heavy rare earth element content is similar to that of the first embodiment.

Out of 100 mass % of the entire mass of the R-T-B based permanent magnet according to the present embodiment, the total rare earth element content (TRE) of the R-T-B based permanent magnet may be 28.50 mass % or more and 31.50 mass % or less or may be 29.50 mass % or more and 31.10 mass % or less.

Out of 100 mass % of the entire mass of the R-T-B based permanent magnet, the Co content of the R-T-B based permanent magnet may be 0.20 mass % or more and 0.80 mass % or less or may be 0.40 mass % or more and 0.70 mass % or less.

The Fe content may substantially be a balance of the R-T-B based permanent magnet.

Out of 100 mass % of the entire mass of the R-T-B based permanent magnet, the B content may be 0.90 mass % or more and 1.02 mass % or less or may be 0.90 mass % or more and 0.98 mass % or less. With a B content of 0.90 mass % or more, two-grain boundaries tend to have an average thickness of 30 nm or less.

Out of 100 mass % of the entire mass of the R-T-B based permanent magnet, the Al content may be 0.40 mass % or more and 0.85 mass % or less or may be 0.48 mass % or more and 0.80 mass % or less.

Out of 100 mass % of the entire mass of the R-T-B based permanent magnet, the Zr content may be 0.21 mass % or more and 0.85 mass % or less or may be 0.32 mass % or more and 0.68 mass % or less.

Out of 100 mass % of the entire mass of the R-T-B based permanent magnet, the Ga content may be 0.04 mass % or more and 0.40 mass % or less or may be 0.08 mass % or more and 0.36 mass % or less.

Out of 100 mass % of the entire mass of the R-T-B based permanent magnet, the Cu content may be 0.03 mass % or more and 0.50 mass % or less, 0.04 mass % or more and 0.45 mass % or less, or 0.05 mass % or more and 0.40 mass % or less.

Out of 100 mass % of the entire mass of the R-T-B based permanent magnet, the C content may be 0.05 mass % or more and 0.11 mass % or less or may be 0.07 mass % or more and 0.09 mass % or less.

Out of 100 mass % of the entire mass of the R-T-B based permanent magnet, the O content may be 0 mass % or more and 0.12 mass % or less or may be 0.06 mass % or more and 0.11 mass % or less.

Hereinafter, an example method of manufacturing the R-T-B based permanent magnet according to the present embodiment is described. The example method of manufacturing the R-T-B based permanent magnet according to the present embodiment is similar to the method of manufacturing the R-T-B based permanent magnet according to the first embodiment, except for the following.

When the two-alloy method is employed, a grain boundary phase alloy with an Al content of 3 mass % or more makes the grain boundaries tend to include the R—Fe—Co—Ga—Al concentrated portion.

The aging time of the second aging step may be 5 hours or less. An aging time of 5 hours or less makes the R—Fe—Co—Ga—Al concentrated portion tend to be included in the near center of the magnet.

The present disclosure is not limited to the above-described embodiments and can variously be modified within the scope of the present disclosure.

Methods of manufacturing the R-T-B based permanent magnet are not limited to the above method and may be changed as appropriate. For example, while the above method of manufacturing the R-T-B based permanent magnet involves sintering, the R-T-B based permanent magnet according to the present embodiment may be manufactured by hot working. A method of manufacturing the R-T-B based permanent magnet by hot working includes the following steps:
(a) a melting and quenching step of melting raw material metals and quenching a resultant molten metal to give a ribbon,
(b) a pulverization step of pulverizing the ribbon to give a flake-like raw material powder,
(c) a cold forming step of cold-forming the raw material powder,
(d) a preheating step of preheating a resultant cold-formed body,
(e) a hot forming step of hot-forming the preheated cold-formed body,
(f) a hot plastic deforming step of plastically deforming the hot-formed body into a predetermined shape, and
(g) an aging treatment step of age-treating a resultant R-T-B based permanent magnet. The aging treatment step may be omitted. Steps from and after the aging treatment step are similar to those of manufacture by sintering.

### Examples

Hereinafter, the present disclosure is described based on further detailed examples. However, the present disclosure is not limited to these examples.

### Manufacture of R-T-B Based Permanent Magnet

A raw material alloy was produced using a strip casting method so that an R-T-B based permanent magnet eventually obtained had a composition of each sample shown in Tables 1 to 3. The Pr content was 0 mass % or more and 12 mass % or less. Tb was not contained in the raw material alloy and was contained only in a diffusing material paste described later. As other elements not described in Tables 1 to 3, N, H, Si, Ca, La, Ce, Cr, or the like may be detected. Si may mainly come from a ferroboron raw material and a crucible used at the time of melting the alloy. Ca, La, and Ce may come from a rare earth raw material. Cr may come from electrolytic iron. In Tables 1 to 3, “bal.” shown as the Fe content indicates that the Fe content was substantially a balance of the R-T-B based permanent magnet out of 100 mass % of the entire R-T-B based permanent magnet including these other elements.

Then, a hydrogen gas flowed for the raw material alloy at room temperature for 1 hour so that hydrogen was stored in the raw material alloy. Then, the atmosphere was switched to an Ar gas, and a dehydrogenation treatment was performed at 500° C. for 1 hour, to perform hydrogen storage pulverization of the raw material alloy.

Then, to the resultant raw material alloy powder, 0.1 mass % oleic amide was added as a pulverization aid, and they were mixed with a Nauta mixer.

Then, the mixture was finely pulverized in a nitrogen stream using an impact plate type jet mill apparatus to give a finely pulverized powder (raw material powder) having an average particle size of about 3.0 μm. The average particle size was an average particle size D50 measured with a laser diffraction type particle size analyzer.

The resultant finely pulverized powder was pressed in a magnetic field to produce a green compact. The magnetic field applied at this time was a static magnetic field of 1200 kA/m. The pressure applied during pressing was 120 MPa. The direction of magnetic field application and the direction of pressure application were orthogonal to each other.

Subsequently, the green compact was sintered to give a sintered body. Optimum sintering conditions depend on the composition or the like. The green compact was held at a temperature within 1030° C. to 1070° C. for 4 hours. The sintering atmosphere was a vacuum. The sintering density at this time was within a range of 7.51 Mg/m³ to 7.55 Mg/m³. The sintered body, with which each sample shown in Tables 1 to 3 was produced through grain boundary diffusion, was thus produced.

### Preparation of Diffusing Material Paste

Next, the diffusing material paste used for grain boundary diffusion was prepared.

A hydrogen gas flowed for metal Tb having a purity of 99.9% at room temperature so that it stored hydrogen. Then, the atmosphere was switched to an Ar gas, and a dehydrogenation treatment was performed at 500° C. for 1 hour, to perform hydrogen storage pulverization of the metal Tb. Then, 0.05 mass % zinc stearate was added as a pulverization aid to 100 mass % metal Tb, and they were mixed with a Nauta mixer. Then, fine pulverization was carried out using a jet mill in an atmosphere having 3000 ppm oxygen to give a finely pulverized powder of a Tb hydride having an average particle size of about 10.0 μm.

60 parts by mass of the finely pulverized powder of the Tb hydride, 10 parts by mass of a Cu powder, 25 parts by mass of alcohol, and 5 parts by mass of acrylic resin were kneaded to prepare the diffusing material paste. The alcohol was a solvent, and the acrylic resin was a binder.

### Coating and Heat Treatment of Diffusing Material Paste

The above sintered body was machined into a size of length 11 mm×width 11 mm×height 4.2 mm (thickness in the direction of an axis of easy magnetization was 4.2 mm). Then, an etching treatment was performed, in which the machined sintered body was immersed in a mixed solution of nitric acid and ethanol (nitric acid:ethanol=3 mass %:100 mass %) for 3 minutes and then in ethanol for 1 minute. This etching treatment, in which the machined sintered body was immersed in the mixed solution for 3 minutes and then in ethanol for 1 minute, was performed twice.

Then, all surfaces of the sintered body after the etching treatment were coated with the above-mentioned diffusing material paste. The coating amount of the diffusing material paste was determined so that the Tb content of the R-T-B based permanent magnet eventually obtained was as shown in Tables 1 to 3.

Then, the sintered body was dried. Specifically, the sintered body coated with the diffusing material paste was left in an Ar gas atmosphere in an oven at 400° C. for 3 hours to remove the solvent and the binder included in the diffusing material paste. Then, while Ar flowed under atmospheric pressure (1 atm), the sintered body was heated for 30 hours at 900° C. Further, while Ar flowed under atmospheric pressure (1 atm), the sintered body was heated for 1 hour at 500° C. as an aging treatment. The above steps gave the R-T-B based permanent magnet of each sample shown in Tables 1 to 3.

The surfaces of the R-T-B based permanent magnet were scraped off by 0.1 mm each. Then, the composition, microstructure, element distribution, magnetic properties, and corrosion resistance were evaluated.

The R-T-B based permanent magnet was machined into a size of length 11 mm×width 11 mm×height 4.2 mm (thickness in the direction of the axis of easy magnetization was 4.2 mm) using a surface grinding machine, and magnetic properties at room temperature were evaluated using a BH tracer. The R-T-B based permanent magnet was magnetized with a pulsed magnetic field of 4000 kA/m before the magnetic properties were measured. Because the R-T-B based permanent magnet had a small thickness, three such magnets were stacked to evaluate the magnetic properties. In the present Examples, Hk/HcJ was represented by Hk/HcJ×100(%), where Hk (kA/m) was the magnetic field at the time when magnetization reached 90% of Br in the J-H demagnetization curve, which was the magnetization J-magnetic field H curve at the second quadrant. Also, HcJ at high temperatures, i.e., HcJ at 150° C. was measured.

In the present Examples, Br of the R-T-B based permanent magnet was defined as good at 1400 mT or more or defined as better at 1410 mT or more. HcJ of the R-T-B based permanent magnet at room temperature was defined as good at 1850 kA/m or more or defined as better at 1900 kA/m or more. HcJ of the R-T-B based permanent magnet at high temperatures was defined as good at 700 kA/m or more or defined as better at 715 kA/m or more. Hk/HcJ of the R-T-B based permanent magnet was defined as good at 93.0% or more or defined as better at 95.0% or more.

The microstructure and the element distribution of the R-T-B based permanent magnet were checked. Specifically, using a field emission type electron probe micro-analyzer (EPMA) manufactured by JEOL Ltd., the microstructure was observed, and elemental mapping was performed. An observation sample workpiece was prepared by cutting out a portion of the magnet that includes its near center and is smaller than a cube having 10-mm long sides, embedding the cut out portion in resin, and mirror polishing the resin-embedded cut out portion. As for measurement conditions, the accelerating voltage was 15 kV. The illumination current was 100 nA. The magnification was 2000×. The field of view had a size of 51.2 μm×51.2 μm.

The R-T-B based permanent magnet was subject to a corrosion resistance test. The corrosion resistance test was performed by a pressure cooker test (PCT) under saturated vapor pressure. Specifically, mass variation of the R-T-B based permanent magnet before and after the test under a pressure of 2 atm for 1000 hours in a 100% RH atmosphere was measured. The corrosion resistance was defined as good when the absolute value of the mass variation per surface area of the R-T-B based permanent magnet was 0.3 mg/cm² or less or defined as better when the absolute value thereof was 0.1 mg/cm² or less. When the R-T-B based permanent magnet itself was shattered, the corrosion resistance column of Tables was marked with “shattered”.

Each sample shown in Tables 1 to 3 was comprehensively evaluated. Samples having all of Br, HcJ at room temperature, HcJ at high temperatures, Hk/HcJ, and corrosion resistance defined as better were rated as “A”. Samples having at least one of Br, HcJ at room temperature, HcJ at high temperatures, Hk/HcJ, and corrosion resistance defined as not good were rated as “C”. Samples that do not apply to “A” or “C” were rated as “B”. Tables 1 to 3 show the results.

TABLE 1

| | | Magnet composition | | | | | | | | | | |
|---|---|---|---|---|---|---|---|---|---|---|---|---|
| | | Nd + | | | | | | | | | | |
| | | Pr | Tb | Co | Fe | B | Al | Zr | Ga | Cu | C | O |
| Sample | Example/ | (mass | (mass | (mass | (mass | (mass | (mass | (mass | (mass | (mass | (mass | (mass |
| No. | Comparative Example | %) | %) | %) | %) | %) | %) | %) | %) | %) | %) | %) |
| 2 | Example | 31.25 | 0.25 | 0.60 | bal. | 0.95 | 0.77 | 0.48 | 0.16 | 0.20 | 0.09 | 0.08 |
| 3 | Example | 30.85 | 0.25 | 0.60 | bal. | 0.95 | 0.77 | 0.48 | 0.16 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 5 | Example | 29.25 | 0.25 | 0.60 | bal. | 0.95 | 0.77 | 0.48 | 0.16 | 0.20 | 0.09 | 0.08 |
| 6 | Example | 28.25 | 0.25 | 0.60 | bal. | 0.95 | 0.77 | 0.48 | 0.16 | 0.20 | 0.09 | 0.08 |
| 9 | Example | 30.45 | 0.25 | 0.60 | bal. | 0.95 | 0.85 | 0.48 | 0.16 | 0.20 | 0.09 | 0.08 |
| 10 | Example | 30.45 | 0.25 | 0.60 | bal. | 0.95 | 0.80 | 0.48 | 0.16 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 11 | Example | 30.45 | 0.25 | 0.60 | bal. | 0.95 | 0.62 | 0.48 | 0.16 | 0.20 | 0.09 | 0.08 |
| 12 | Example | 30.45 | 0.25 | 0.60 | bal. | 0.95 | 0.48 | 0.48 | 0.16 | 0.20 | 0.09 | 0.08 |
| 13 | Example | 30.45 | 0.25 | 0.60 | bal. | 0.95 | 0.40 | 0.48 | 0.16 | 0.20 | 0.09 | 0.08 |
| 14 | Comparative Example | 30.45 | 0.25 | 0.60 | bal. | 0.95 | 0.35 | 0.48 | 0.16 | 0.20 | 0.09 | 0.08 |
| 15 | Comparative Example | 30.45 | 0.25 | 0.60 | bal. | 0.95 | 0.30 | 0.48 | 0.16 | 0.20 | 0.09 | 0.08 |
| 16 | Example | 30.45 | 0.25 | 0.80 | bal. | 0.95 | 0.77 | 0.48 | 0.16 | 0.20 | 0.09 | 0.08 |
| 17 | Example | 30.45 | 0.25 | 0.70 | bal. | 0.95 | 0.77 | 0.48 | 0.16 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 18 | Example | 30.45 | 0.25 | 0.40 | bal. | 0.95 | 0.77 | 0.48 | 0.16 | 0.20 | 0.09 | 0.08 |
| 19 | Example | 30.45 | 0.25 | 0.20 | bal. | 0.95 | 0.77 | 0.48 | 0.16 | 0.20 | 0.09 | 0.08 |
| 20 | Comparative Example | 30.45 | 0.25 | 0.14 | bal. | 0.95 | 0.77 | 0.48 | 0.16 | 0.20 | 0.09 | 0.08 |

| | | | | | Magnetic properties | | | | Corrosion | |
|---|---|---|---|---|---|---|---|---|---|---|
| | Magnet composition | | | | | | HcJ at | | resistance | |
| | HRE | TRE | | | | | high | | Mass | |
| Sample | (mass | (mass | Ga/ | C/ | Br | HcJ | temperature | Hk/HcJ | variation | Comprehensive |
| No. | %) | %) | Al | (Zr + B) | (mT) | (kA/m) | (kA/m) | (%) | (mg/cm³) | evaluation |
| 2 | 0.25 | 31.50 | 0.21 | 0.063 | 1406 | 1924 | 722 | 98.5 | −0.3 | B |
| 3 | 0.25 | 31.10 | 0.21 | 0.063 | 1420 | 1918 | 722 | 97.7 | −0.1 | A |
| 4 | 0.25 | 30.70 | 0.21 | 0.063 | 1424 | 1923 | 721 | 97.4 | −0.1 | A |
| 5 | 0.25 | 29.50 | 0.21 | 0.063 | 1422 | 1917 | 718 | 97.2 | −0.1 | A |
| 6 | 0.25 | 28.50 | 0.21 | 0.063 | 1418 | 1892 | 713 | 96.8 | 0.0 | B |
| 9 | 0.25 | 30.70 | 0.19 | 0.063 | 1404 | 1922 | 704 | 97.2 | −0.1 | B |
| 10 | 0.25 | 30.70 | 0.20 | 0.063 | 1413 | 1924 | 718 | 97.8 | −0.1 | A |
| 4 | 0.25 | 30.70 | 0.21 | 0.063 | 1424 | 1923 | 721 | 97.4 | −0.1 | A |
| 11 | 0.25 | 30.70 | 0.26 | 0.063 | 1422 | 1920 | 728 | 97.9 | 0.1 | A |
| 12 | 0.25 | 30.70 | 0.33 | 0.063 | 1427 | 1914 | 723 | 98.0 | −0.1 | A |
| 13 | 0.25 | 30.70 | 0.40 | 0.063 | 1427 | 1892 | 713 | 97.5 | −0.1 | B |
| 14 | 0.25 | 30.70 | 0.46 | 0.063 | 1428 | 1845 | 697 | 97.2 | −0.2 | C |
| 15 | 0.25 | 30.70 | 0.53 | 0.063 | 1430 | 1836 | 688 | 96.6 | −0.1 | C |
| 16 | 0.25 | 30.70 | 0.21 | 0.063 | 1408 | 1920 | 725 | 97.5 | 0.0 | B |
| 17 | 0.25 | 30.70 | 0.21 | 0.063 | 1416 | 1921 | 724 | 97.4 | −0.1 | A |
| 4 | 0.25 | 30.70 | 0.21 | 0.063 | 1420 | 1923 | 721 | 97.4 | −0.1 | A |
| 18 | 0.25 | 30.70 | 0.21 | 0.063 | 1423 | 1927 | 722 | 97.4 | −0.1 | A |
| 19 | 0.25 | 30.70 | 0.21 | 0.063 | 1417 | 1925 | 725 | 97.6 | −0.3 | B |
| 20 | 0.25 | 30.70 | 0.21 | 0.063 | 1418 | 1921 | 725 | 97.3 | Shattered | C |

TABLE 2

| | | Magnet composition | | | | | | | | | | |
|---|---|---|---|---|---|---|---|---|---|---|---|---|
| | | Nd + | | | | | | | | | | |
| | | Pr | Tb | Co | Fe | B | Al | Zr | Ga | Cu | C | O |
| Sample | Example/ | (mass | (mass | (mass | (mass | (mass | (mass | (mass | (mass | (mass | (mass | (mass |
| No. | Comparative Example | %) | %) | %) | %) | %) | %) | %) | %) | %) | %) | %) |
| 22 | Example | 30.45 | 0.25 | 0.60 | bal. | 0.95 | 0.77 | 0.85 | 0.16 | 0.20 | 0.09 | 0.08 |
| 23 | Example | 30.45 | 0.25 | 0.60 | bal. | 0.95 | 0.77 | 0.68 | 0.16 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 24 | Example | 30.45 | 0.25 | 0.60 | bal. | 0.95 | 0.77 | 0.32 | 0.16 | 0.20 | 0.09 | 0.08 |
| 25 | Example | 30.45 | 0.25 | 0.60 | bal. | 0.95 | 0.77 | 0.21 | 0.16 | 0.20 | 0.09 | 0.08 |
| 28 | Example | 30.45 | 0.25 | 0.60 | bal. | 0.95 | 0.77 | 0.48 | 0.40 | 0.20 | 0.09 | 0.08 |
| 29a | Example | 30.45 | 0.25 | 0.60 | bal. | 0.95 | 0.77 | 0.48 | 0.36 | 0.20 | 0.09 | 0.08 |
| 29 | Example | 30.45 | 0.25 | 0.60 | bal. | 0.95 | 0.77 | 0.48 | 0.30 | 0.20 | 0.09 | 0.08 |
| 30 | Example | 30.45 | 0.25 | 0.60 | bal. | 0.95 | 0.77 | 0.48 | 0.25 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 31 | Example | 30.45 | 0.25 | 0.60 | bal. | 0.95 | 0.77 | 0.48 | 0.08 | 0.20 | 0.09 | 0.08 |
| 32 | Example | 30.45 | 0.25 | 0.60 | bal. | 0.95 | 0.77 | 0.48 | 0.04 | 0.20 | 0.09 | 0.08 |
| 33 | Comparative Example | 30.45 | 0.25 | 0.60 | bal. | 0.95 | 0.77 | 0.48 | 0.02 | 0.20 | 0.09 | 0.08 |
| 35 | Example | 30.45 | 0.25 | 0.60 | bal. | 1.02 | 0.77 | 0.48 | 0.16 | 0.20 | 0.09 | 0.08 |
| 36 | Example | 30.45 | 0.25 | 0.60 | bal. | 0.98 | 0.77 | 0.48 | 0.16 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 37 | Example | 30.45 | 0.25 | 0.60 | bal. | 0.90 | 0.77 | 0.48 | 0.16 | 0.20 | 0.09 | 0.08 |
| 40 | Example | 30.45 | 0.25 | 0.60 | bal. | 0.95 | 0.77 | 0.48 | 0.16 | 0.20 | 0.11 | 0.08 |
| 4 | Example | 30.45 | 0.25 | 0.60 | bal. | 0.95 | 0.77 | 0.48 | 0.16 | 0.20 | 0.09 | 0.08 |
| 41 | Example | 30.45 | 0.25 | 0.60 | bal. | 0.95 | 0.77 | 0.48 | 0.16 | 0.20 | 0.07 | 0.08 |
| 42 | Example | 30.45 | 0.25 | 0.60 | bal. | 0.95 | 0.77 | 0.48 | 0.16 | 0.20 | 0.05 | 0.08 |

| | | | | | Magnetic properties | | | | Corrosion | |
|---|---|---|---|---|---|---|---|---|---|---|
| | Magnet composition | | | | | | HcJ at | | resistance | |
| | HRE | TRE | | | | | high | | Mass | |
| Sample | (mass | (mass | Ga/ | C/ | Br | HcJ | temperature | Hk/HcJ | variation | Comprehensive |
| No. | %) | %) | Al | (Zr + B) | (mT) | (kA/m) | (kA/m) | (%) | (mg/cm³) | evaluation |
| 22 | 0.25 | 30.70 | 0.21 | 0.050 | 1406 | 1911 | 730 | 98.7 | −0.1 | B |
| 23 | 0.25 | 30.70 | 0.21 | 0.055 | 1418 | 1922 | 720 | 97.5 | −0.1 | A |
| 4 | 0.25 | 30.70 | 0.21 | 0.063 | 1424 | 1923 | 721 | 97.4 | −0.1 | A |
| 24 | 0.25 | 30.70 | 0.21 | 0.071 | 1423 | 1934 | 724 | 97.4 | −0.1 | A |
| 25 | 0.25 | 30.70 | 0.21 | 0.078 | 1422 | 1885 | 710 | 94.5 | −0.1 | B |
| 28 | 0.25 | 30.70 | 0.52 | 0.063 | 1406 | 1925 | 724 | 96.7 | −0.1 | B |
| 29a | 0.25 | 30.70 | 0.47 | 0.063 | 1414 | 1929 | 724 | 97.2 | −0.1 | A |
| 29 | 0.25 | 30.70 | 0.39 | 0.063 | 1419 | 1930 | 725 | 97.8 | −0.1 | A |
| 30 | 0.25 | 30.70 | 0.32 | 0.063 | 1421 | 1926 | 723 | 97.5 | −0.1 | A |
| 4 | 0.25 | 30.70 | 0.21 | 0.063 | 1424 | 1923 | 721 | 97.4 | −0.1 | A |
| 31 | 0.25 | 30.70 | 0.10 | 0.063 | 1425 | 1920 | 719 | 97.3 | −0.1 | A |
| 32 | 0.25 | 30.70 | 0.05 | 0.063 | 1425 | 1895 | 708 | 97.2 | −0.1 | B |
| 33 | 0.25 | 30.70 | 0.03 | 0.063 | 1420 | 1810 | 646 | 97.1 | −0.1 | C |
| 35 | 0.25 | 30.70 | 0.21 | 0.060 | 1422 | 1889 | 706 | 97.3 | −0.1 | B |
| 36 | 0.25 | 30.70 | 0.21 | 0.062 | 1420 | 1919 | 718 | 97.6 | −0.1 | A |
| 4 | 0.25 | 30.70 | 0.21 | 0.063 | 1424 | 1923 | 721 | 97.4 | −0.1 | A |
| 37 | 0.25 | 30.70 | 0.21 | 0.065 | 1423 | 1917 | 721 | 98.3 | −0.1 | A |
| 40 | 0.25 | 30.70 | 0.21 | 0.077 | 1420 | 1903 | 710 | 94.5 | −0.1 | B |
| 4 | 0.25 | 30.70 | 0.21 | 0.063 | 1424 | 1923 | 721 | 97.4 | −0.1 | A |
| 41 | 0.25 | 30.70 | 0.21 | 0.049 | 1418 | 1920 | 724 | 97.6 | −0.1 | A |
| 42 | 0.25 | 30.70 | 0.21 | 0.035 | 1409 | 1922 | 722 | 98.0 | −0.1 | B |

TABLE 3

| | | Magnet composition | | | | | | | | | | |
|---|---|---|---|---|---|---|---|---|---|---|---|---|
| | | Nd + | | | | | | | | | | |
| | | Pr | Tb | Co | Fe | B | Al | Zr | Ga | Cu | C | O |
| Sample | Example/ | (mass | (mass | (mass | (mass | (mass | (mass | (mass | (mass | (mass | (mass | (mass |
| No. | Comparative Example | %) | %) | %) | %) | %) | %) | %) | %) | %) | %) | %) |
| 44 | Example | 30.45 | 0.25 | 0.60 | bal. | 0.95 | 0.59 | 0.48 | 0.38 | 0.20 | 0.09 | 0.08 |
| 45 | Example | 30.45 | 0.25 | 0.60 | bal. | 0.95 | 0.68 | 0.48 | 0.36 | 0.20 | 0.09 | 0.08 |
| 46 | Example | 30.45 | 0.25 | 0.60 | bal. | 0.95 | 0.77 | 0.48 | 0.25 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 47 | Example | 30.45 | 0.25 | 0.60 | bal. | 0.95 | 0.80 | 0.48 | 0.10 | 0.20 | 0.09 | 0.08 |
| 48 | Example | 30.45 | 0.25 | 0.60 | bal. | 0.95 | 0.77 | 0.48 | 0.08 | 0.20 | 0.09 | 0.08 |
| 49 | Example | 30.45 | 0.25 | 0.60 | bal. | 0.95 | 0.77 | 0.48 | 0.04 | 0.20 | 0.09 | 0.08 |
| 50 | Example | 30.45 | 0.25 | 0.60 | bal. | 0.91 | 0.77 | 0.22 | 0.16 | 0.20 | 0.11 | 0.08 |
| 51 | Example | 30.45 | 0.25 | 0.60 | bal. | 0.95 | 0.77 | 0.23 | 0.16 | 0.20 | 0.11 | 0.08 |
| 4 | Example | 30.45 | 0.25 | 0.60 | bal. | 0.95 | 0.77 | 0.48 | 0.16 | 0.20 | 0.09 | 0.08 |
| 52 | Example | 30.45 | 0.25 | 0.60 | bal. | 1.00 | 0.77 | 0.60 | 0.16 | 0.20 | 0.05 | 0.08 |
| 53 | Comparative Example | 30.39 | 0.31 | 0.60 | bal. | 0.95 | 0.77 | 0.48 | 0.16 | 0.20 | 0.09 | 0.08 |
| 54 | Example | 30.40 | 0.30 | 0.60 | bal. | 0.95 | 0.77 | 0.48 | 0.16 | 0.20 | 0.09 | 0.08 |
| 4 | Example | 30.45 | 0.25 | 0.60 | bal. | 0.95 | 0.77 | 0.48 | 0.16 | 0.20 | 0.09 | 0.08 |
| 55 | Example | 30.55 | 0.15 | 0.60 | bal. | 0.95 | 0.77 | 0.48 | 0.16 | 0.20 | 0.09 | 0.08 |
| 56 | Example | 30.60 | 0.10 | 0.60 | bal. | 0.95 | 0.77 | 0.48 | 0.16 | 0.20 | 0.09 | 0.08 |
| 58 | Example | 30.45 | 0.25 | 0.60 | bal. | 0.95 | 0.77 | 0.48 | 0.16 | 0.20 | 0.09 | 0.12 |
| 59 | Example | 30.45 | 0.25 | 0.60 | bal. | 0.95 | 0.77 | 0.48 | 0.16 | 0.20 | 0.09 | 0.11 |
| 4 | Example | 30.45 | 0.25 | 0.60 | bal. | 0.95 | 0.77 | 0.48 | 0.16 | 0.20 | 0.09 | 0.08 |
| 60 | Example | 30.45 | 0.25 | 0.60 | bal. | 0.95 | 0.77 | 0.48 | 0.16 | 0.20 | 0.09 | 0.06 |

| | | | | | Magnetic properties | | | | Corrosion | |
|---|---|---|---|---|---|---|---|---|---|---|
| | Magnet composition | | | | | | HcJ at | | resistance | |
| | HRE | TRE | | | | | high | | Mass | |
| Sample | (mass | (mass | Ga/ | C/ | Br | HcJ | temperature | Hk/HcJ | variation | Comprehensive |
| No. | %) | %) | Al | (Zr + B) | (mT) | (kA/m) | (kA/m) | (%) | (mg/cm³) | evaluation |
| 44 | 0.25 | 30.70 | 0.64 | 0.063 | 1417 | 1896 | 707 | 97.3 | −0.3 | B |
| 45 | 0.25 | 30.70 | 0.53 | 0.063 | 1417 | 1909 | 717 | 97.5 | −0.1 | A |
| 46 | 0.25 | 30.70 | 0.32 | 0.063 | 1420 | 1915 | 721 | 97.5 | −0.1 | A |
| 4 | 0.25 | 30.70 | 0.21 | 0.063 | 1424 | 1923 | 721 | 97.4 | −0.1 | A |
| 47 | 0.25 | 30.70 | 0.13 | 0.063 | 1423 | 1924 | 719 | 97.3 | −0.1 | A |
| 48 | 0.25 | 30.70 | 0.10 | 0.063 | 1425 | 1920 | 719 | 97.3 | −0.1 | A |
| 49 | 0.25 | 30.70 | 0.05 | 0.063 | 1425 | 1895 | 708 | 97.2 | −0.1 | B |
| 50 | 0.25 | 30.70 | 0.21 | 0.096 | 1418 | 1920 | 727 | 93.3 | −0.1 | B |
| 51 | 0.25 | 30.70 | 0.21 | 0.090 | 1421 | 1915 | 718 | 95.4 | −0.1 | A |
| 4 | 0.25 | 30.70 | 0.21 | 0.063 | 1424 | 1923 | 721 | 97.4 | −0.1 | A |
| 52 | 0.25 | 30.70 | 0.21 | 0.031 | 1422 | 1923 | 720 | 97.5 | −0.1 | A |
| 53 | 0.31 | 30.70 | 0.21 | 0.063 | 1398 | 1935 | 731 | 97.0 | −0.1 | C |
| 54 | 0.30 | 30.70 | 0.21 | 0.063 | 1406 | 1935 | 730 | 97.2 | −0.1 | B |
| 4 | 0.25 | 30.70 | 0.21 | 0.063 | 1424 | 1923 | 721 | 97.4 | −0.1 | A |
| 55 | 0.15 | 30.70 | 0.21 | 0.063 | 1428 | 1915 | 717 | 97.6 | −0.1 | A |
| 56 | 0.10 | 30.70 | 0.21 | 0.063 | 1431 | 1907 | 712 | 97.7 | −0.1 | B |
| 58 | 0.25 | 30.70 | 0.21 | 0.063 | 1407 | 1886 | 700 | 96.2 | −0.1 | B |
| 59 | 0.25 | 30.70 | 0.21 | 0.063 | 1418 | 1920 | 715 | 97.4 | −0.1 | A |
| 4 | 0.25 | 30.70 | 0.21 | 0.063 | 1424 | 1923 | 721 | 97.4 | −0.1 | A |
| 60 | 0.25 | 30.70 | 0.21 | 0.063 | 1423 | 1918 | 718 | 97.2 | −0.1 | A |

According to Tables 1 to 3, each Example, in which the entire composition was within a specific range, had good magnetic properties and good corrosion resistance.

According to Table 1, Sample Nos. 14 and 15, in which the Al content was too low, had low HcJ at room temperature and low HcJ at high temperatures. Sample No. 20, in which the Co content was too low, had low corrosion resistance.

According to Table 2, Sample No. 33, in which the Ga content was too low, had low HcJ at room temperature and low HcJ at high temperatures.

According to Table 3, Sample No. 53, in which HRE was too high, had low Br.

The Tb concentration distributions of the R-T-B based permanent magnets of all Examples and all Comparative Examples were analyzed using an electron probe micro-analyzer (EPMA); and it was confirmed that the Tb concentrations decreased from outer sides to inner sides of the magnets.

It was confirmed that two-grain boundaries of the R-T-B based permanent magnets of all Examples had an average thickness of 30 nm or less.

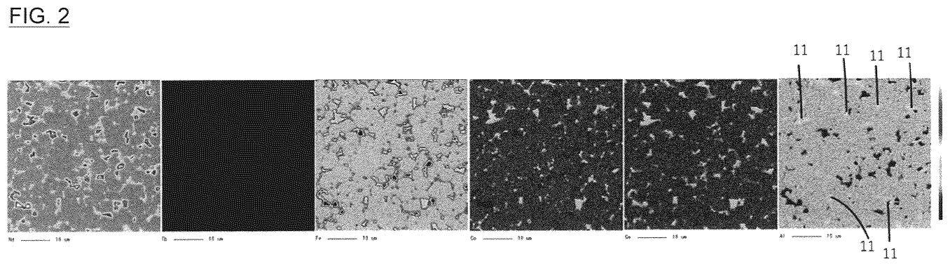

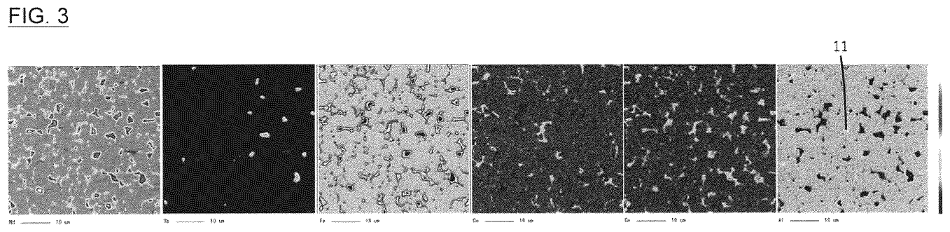

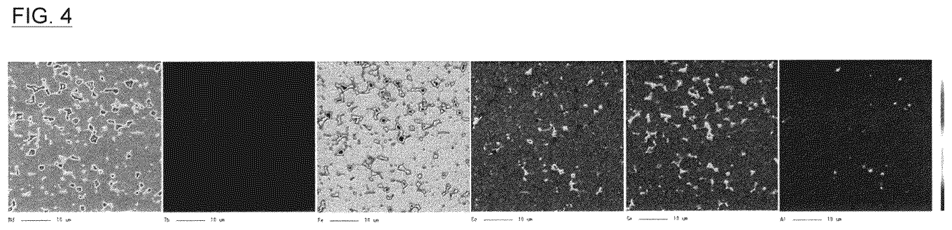

FIG. 2 shows EPMA elemental mapping results of a portion (near center) of the Sample No. 4 magnet apart by 2 mm from a surface of the magnet. FIG. 3 shows EPMA elemental mapping results of a portion (vicinity of the surface) of the Sample No. 4 magnet apart by 100 μm from the surface of the magnet. FIG. 4 shows EPMA elemental mapping results of a portion (near center) of the Sample No. 15 magnet apart by 2 mm from a surface of the magnet. Each of these figures includes, ordered from left to right, a Nd mapping image, a Tb mapping image, an Fe mapping image, a Co mapping image, a Ga mapping image, and an Al mapping image, in the order mentioned. The Al mapping image shows locations of R—Fe—Co—Ga—Al concentrated portions 11. The elemental mapping results of FIGS. 2 and 3 revealed that, in the Sample No. 4 magnet, the R—Fe—Co—Ga—Al concentrated portions 11 were present in grain boundaries. Regions in which all of “R”, Fe, Co, Ga, and Al were highly concentrated in the elemental mapping results of FIGS. 2 to 4 were the R—Fe—Co—Ga—Al concentrated portions 11. The R—Fe—Co—Ga—Al concentrated portions 11 were particularly included in the grain boundaries at the near center of the magnet more than in the grain boundaries in the vicinity of the surface of the magnet. By contrast, in Sample No. 15, no R—Fe—Co—Ga—Al concentrated portion 11 was observed in the grain boundaries.

It was confirmed that, in the magnets of all Examples, the R—Fe—Co—Ga—Al concentrated portions 11 were included in the grain boundaries and were particularly included more in the grain boundaries at the near center of each magnet than in the grain boundaries in the vicinity of the surface of the magnet, similarly to the Sample No. 4 magnet. By contrast, it was confirmed that, in Sample Nos. 14, 20, and 33, no R—Fe—Co—Ga—Al concentrated portion 11 was observed in the grain boundaries, similarly to Sample No. 15.

### REFERENCE NUMERALS

1 . . . R-T-B based permanent magnet
11 . . . R—Fe—Co—Ga—Al concentrated portion

What is claimed is:

1. An R-T-B based permanent magnet comprising at least a rare earth element, Fe, Co, Al, Zr, Ga, B, and C, the rare earth element comprising a heavy rare earth element, wherein the R-T-B based permanent magnet has
a rare earth element content of 28.50 mass % or more and 31.50 mass % or less,
a heavy rare earth element content of 0.30 mass % or less excluding 0 mass %,
a Co content of 0.20 mass % or more and 0.80 mass % or less,
an Al content of 0.40 mass % or more and 0.85 mass % or less,
a Zr content of 0.21 mass % or more and 0.85 mass % or less,
a Ga content of 0.04 mass % or more and 0.40 mass % or less,
a B content of 0.90 mass % or more and 1.02 mass % or less,
a C content of 0.05 mass % or more and 0.11 mass % or less, and
an O content of 0 mass % or more and 0.12 mass % or less.

2. The R-T-B based permanent magnet according to claim 1, wherein the Ga content divided by the Al content based on mass is 0.04 or more and 0.59 or less.

3. The R-T-B based permanent magnet according to claim 1, wherein the C content divided by a total of the Zr content and the B content based on mass is 0.026 or more and 0.095 or less.

4. The R-T-B based permanent magnet according to claim 1 having a distribution of concentrations of the heavy rare earth element decreasing from a surface of the R-T-B based permanent magnet inwards.

5. An R-T-B based permanent magnet comprising:
main phase grains comprising crystal grains having an R₂T₁₄B type crystal structure; and
a grain boundary between two or more of the main phase grains adjacent to each other, wherein
the grain boundary comprises an R—Fe—Co—Ga—Al concentrated portion;
the R—Fe—Co—Ga—Al concentrated portion comprises a portion containing Fe, having a rare earth element concentration higher than an average rare earth element concentration of the main phase grains, having a Co concentration higher than an average Co concentration of the main phase grains, having a Ga concentration higher than an average Ga concentration of the main phase grains, and having an Al concentration higher than an average Al concentration of the main phase grains; and
the R-T-B based permanent magnet has a heavy rare earth element content of 0.30 mass % or less excluding 0 mass %.

6. The R-T-B based permanent magnet according to claim 5 comprising the R—Fe—Co—Ga—Al concentrated portion at a near center of the R-T-B based permanent magnet.

7. The R-T-B based permanent magnet according to claim 5 comprising at least a rare earth element, Fe, Co, Al, Zr, Ga, B, and C and having
a rare earth element content of 28.50 mass % or more and 31.50 mass % or less,
a Co content of 0.20 mass % or more and 0.80 mass % or less,
an Al content of 0.40 mass % or more and 0.85 mass % or less,
a Zr content of 0.21 mass % or more and 0.85 mass % or less,
a Ga content of 0.04 mass % or more and 0.40 mass % or less,
a B content of 0.90 mass % or more and 1.02 mass % or less,
a C content of 0.05 mass % or more and 0.11 mass % or less, and
an O content of 0 mass % or more and 0.12 mass % or less.
